(19) United States
(12) Patent Application Publication
(10) Pub. No.: US 2008/0162037 A1
(43) Pub. Date: Jul. 3, 2008

(54) Location-based interactive display and communication system

(76) Inventor: Ashraf S. Hasan Mahmoud, Dhahran (SA)

Correspondence Address: LITMAN LAW OFFICES, LTD., P.O. BOX 15035, CRYSTAL CITY STATION, ARLINGTON, VA, 22215, US

(21) Appl. No.: 11/645,727

(22) Filed: Dec. 27, 2006

(51) Int. Cl. G01C 21/00; G01S 5/00; G06Q 30/00

(52) U.S. Cl. 701/208; 701/213; 705/14

(57) ABSTRACT

The location-based interactive display and communication device and method of using the same provides a mobile device having a housing, a processor, a display, a storage medium adapted for storing a database, a user interface, a communication device and a positioning device. The positioning device determines the geographic location of the mobile device and a visual map of the geographic region about the geographic location is displayed on the display of the mobile device. Icons relating to user-selectable areas of interest are further displayed on the visual map, and the user may select a particular icon to show information related to the particular area of interest. The user may then communicate with the particular area of interest and, further, advertisements related to the geographic region may be selectively displayed on the display. A plurality of visual maps and related information may be stored in the database.

### BACKGROUND OF THE INVENTION

1. Field of the Invention

The present invention relates to a system that facilitates tourism, and particularly to a location-based interactive display and communication system that includes a portable device that displays maps with cites of interest to tourists, a GPS device so that the the user can determine his or her current location and directions to a cite of interest, a communications device for comuunicating by voice or by Internet with the cite of interest, and advertising of cites of interest to tourists with links for updating the advertisements and communicating with cites of interest.

2. Description of the Related Art

Many towns, cities and commercial interests, such as hotels, would like to increase their tourist trade. Tourists are often hesitant to explore new locales and geographic regions due to a general lack of information regarding the regions of interest. Although maps and guidebooks are often made available to tourists, it is inconvenient to carry multiple maps and guides and, further, the information available in printed material is often quite limited. Further, such information is not personalized or customizable for the user.

Tour guides or tourist centers staffed by people knowledgeable about the region may offer tourists personalized or customized information. However, such services are often tailored for large groups, rather than individuals. Further, tourists often must pay for such services, in addition to their travel expenses.

Although customizable information and maps are available to users on large scale computer networks, such as the Internet, this information is static; i.e., the information must be searched with regard to a set geographic location and does not change dependent upon the user's physical location. It would be desirable to provide an information system which automatically determines the user's location and provides information based upon that location, without the user having to look up a multiplicity of geographic regions on his or her computer.

Although the information searched may include communication information, such as a telephone number or e-mail address for a hotel of interest, the user must then separately contact the location, which requires additional software (in the form of an e-mail program, for example) or additional hardware, such as a telephone.

Thus, a location-based interactive display and communication device and method of using the same solving the aforementioned problems is desired.

### SUMMARY OF THE INVENTION

The location-based interactive display and communication system includes a portable device, such as a notebook computer or personal digital assistant (PDA), having a housing, a processor, a display, a storage medium adapted for storing a database, a user interface, a communication device and a positioning device. The mobile device may be a cellular telephone, a personal digital assistant (PDA) with communication capability, a portable computer with a modem or other communication capability communication capability, or the like. The positioning device determines the geographic location of the mobile device, and a visual map of the geographic region about the geographic location is displayed on the display of the mobile device. The positioning device may communicate with the global positioning system (GPS) or a local service provider. The local service provider may be a local Internet Service Provider, a local cellular telephone network or the like. Alternatively, the local service provider may be a communication source associated with a particular area of interest within the geographic region, such as a hotel.

Icons relating to user-selectable areas of interest are further displayed on the visual map, and the user may select a particular icon to show information related to the particular area of interest. The visual maps, icons, and information related to the geographic regions are preferably stored within the database. Following selection of a particular icon, the user may then communicate with the particular area of interest (such as the exemplary hotel, noted above) and, further, advertisements related to the geographic region may be selectively displayed on the display. The advertisements may also be stored in the database and, further, may be updated by the local service provider.

These and other features of the present invention will become readily apparent upon further review of the following specification and drawings.

### BRIEF DESCRIPTION OF THE DRAWINGS

FIG. 1 is a block diagram of a location-based interactive display and communication system according to the present invention.

FIG. 2 is a front view of an exemplary location-based interactive display and communication device in a system according to the present invention, shown in a first mode of operation.

FIG. 3 is a front view of the location-based interactive display and communication device of FIG. 2, shown in a second mode of operation.

FIG. 4 is a front view of the location-based interactive display and communication device of FIGS. 2-3, shown in a third mode of operation.

FIG. 5 is a block diagram illustrating the sub-systems of the location-based interactive display and communication system according to the present invention.

FIG. 6 is a flow diagram illustrating a method of using the location-based interactive display and communication system according to the present invention.

Similar reference characters denote corresponding features consistently throughout the attached drawings.

### DETAILED DESCRIPTION OF THE PREFERRED EMBODIMENTS

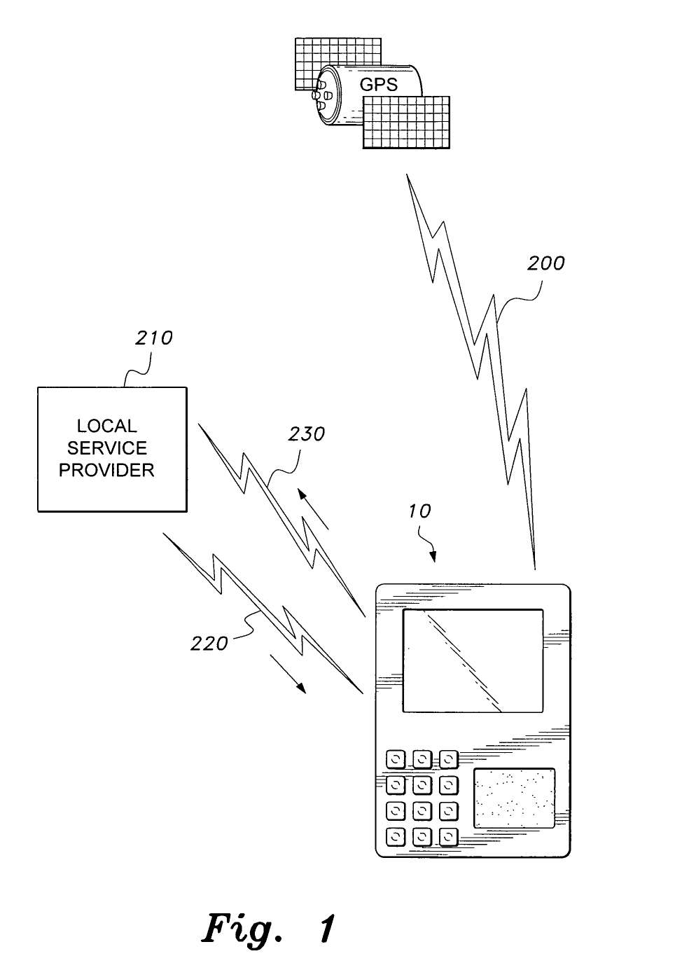

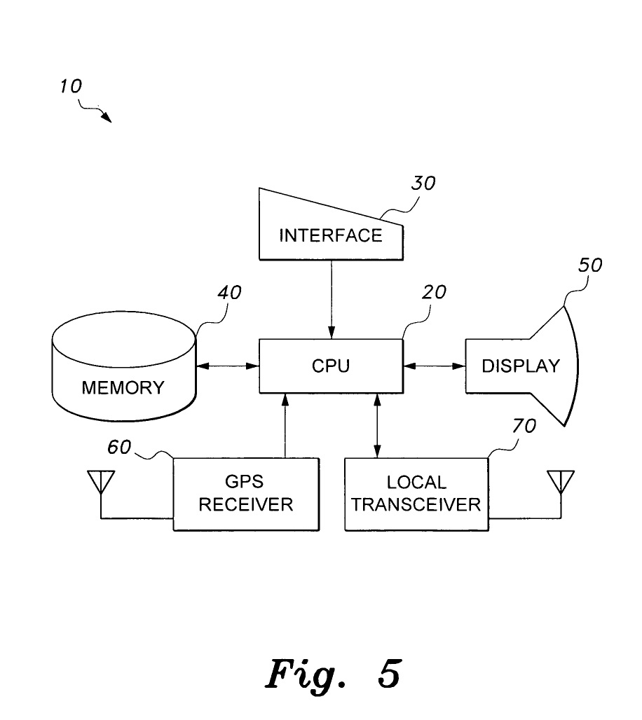

The present invention is directed towards a location-based interactive display and communication system that incorporates a location-based display and communication device 10. As best shown in FIGS. 1, 2 and 5, the system makes use of a portable device 10 is a mobile device having a housing 12, a central processing unit (CPU) 20, a display 50, a memory storage medium 40 adapted for storing a database, a user interface 30, a local communication transceiver device 70 and a positioning device 60. The mobile device 10 may be a laptop computer, a cellular telephone, a personal digital assistant (PDA) with communication capability, a hand-held computer or any other portable computing device with communication and positioning capability.

The positioning device 60 determines the geographic location of the mobile device 10, and may be a communication device adapted for communicating with the global positioning system (GPS) via GPS radio frequency (RF) signals 200, or may be a communication device which sends and receives signals 230, 220 to and from a local service provider 210 (as shown in FIG. 1) in order to determine the geographic location of device 10.

The local service provider 210 may be a local Internet service provider (ISP), a local cellular telephone network, or may be a source of local computer network access, such as, for example, a computer associated with a local area of interest, such as hotel, for example, enabled with wireless broadband network access, such as a Bluetooth protocol enabled wireless network system, for example. The local communication transceiver 70 is adapted for communication with local service provider 210 and may be a cellular telephone communication system, a modem, a Bluetooth® transceiver, a Wi-Fi modem or the like. The nature of communication device 70 is dependent upon the needs and desires of the user, and further upon the nature of mobile device 10. Preferably, mobile device 10 is equipped with at least general packet radio service (GPRS) connectivity. At present, the standard for GPS enabled cellular telephones is the global system for mobile communications (GSM) and, preferably, mobile device 10 is adapted for communication via the GSM system.

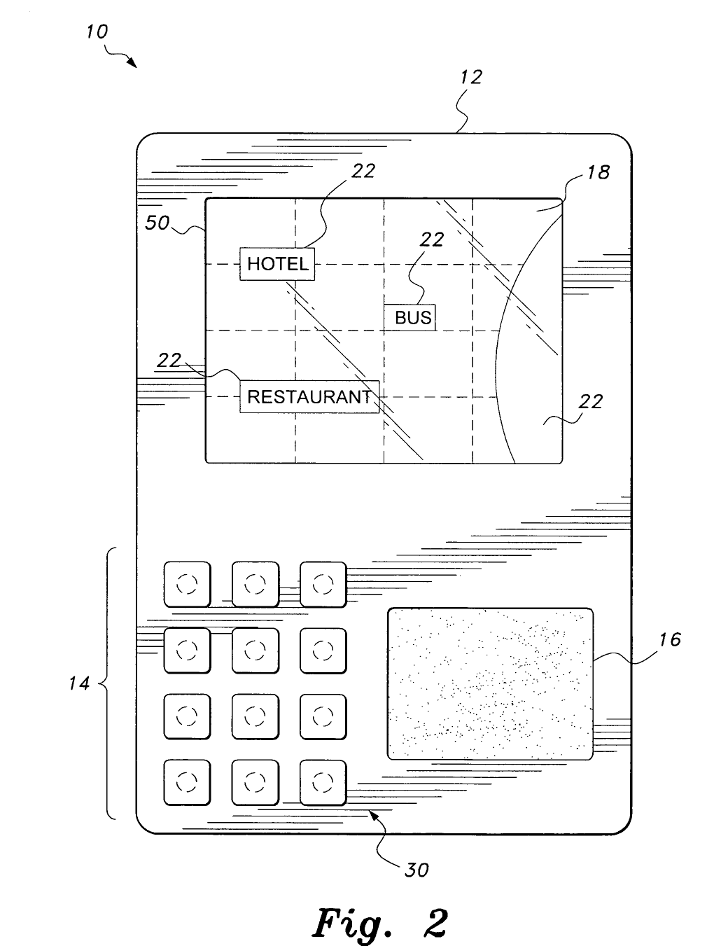

As shown in FIGS. 2-4, the device 10 includes a housing 12 and a display 50. Display 50 may be a liquid crystal display (LCD), as shown, or any other suitable visual display in communication with CPU 20. A user interface 30 is further mounted on housing 12, and may include, for example, a keypad or keyboard 14 and a touchpad 16, as shown. It should be understood that keypad 14 and touchpad 16 are shown in FIGS. 2-4 for exemplary purposes only, and that any suitable user interface 30 may be utilized, dependent upon the needs and desires of the user, and dependent upon the nature of the selected mobile device 10.

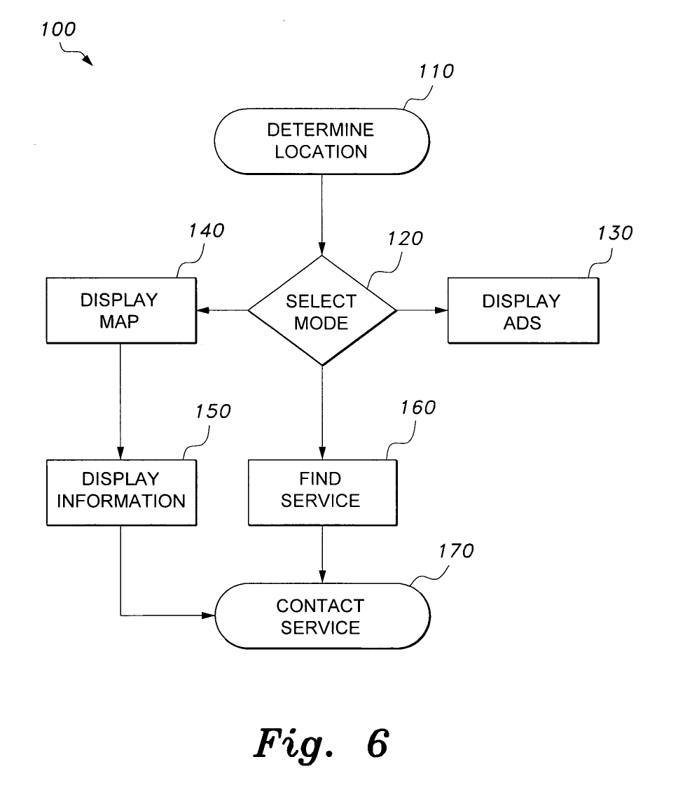

In use, the user actuates mobile device 10, which receives locating signals from either the GPS or local service provider 210. Once the location of device 10 has been determined (step 110 in the flow diagram 100 of FIG. 6), the user may select a mode of operation (step 120). As will be described in greater detail below, device 10 may be selectively used to display a map 18, may be used to display information regarding areas of interest (step 150), or may be used to display geographic-dependent advertisements (step 130).

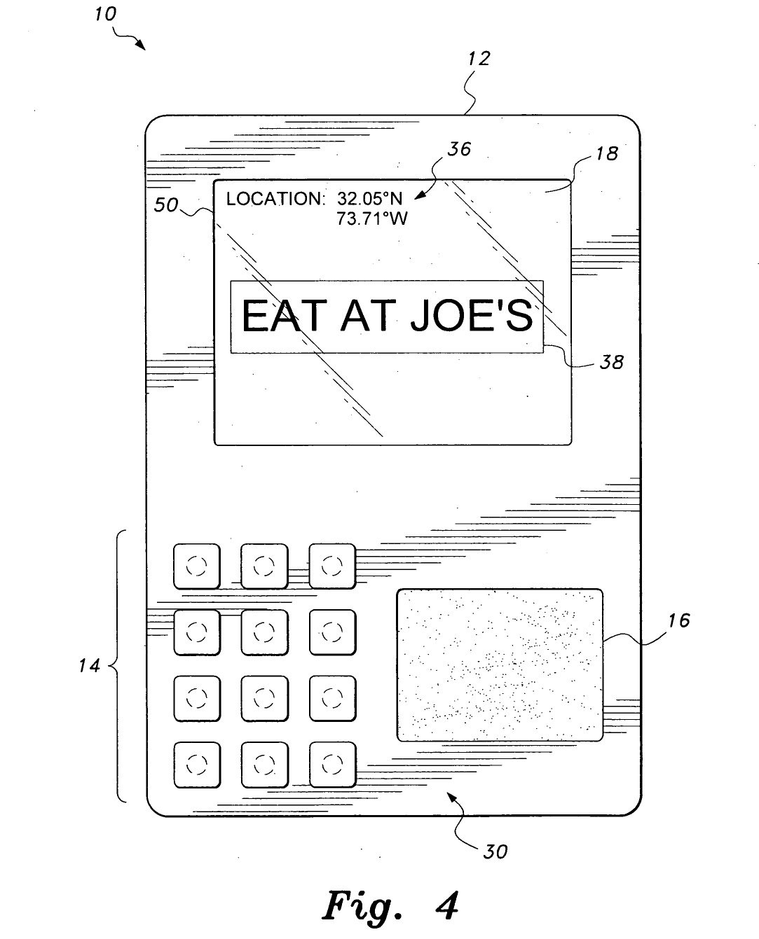

FIG. 2 illustrates a visual map 1 8 being displayed on display 50 of device 10. Once the geographic location of device 10 has been determined, a geographic region about the geographic location is defined, with the dimensions of the geographic region being user selectable. Map 18 is a visual representation of the geographic region about the geographic location of the user and device 10. A set of maps 18 may be stored in the database, stored in memory 40 of device 10. As shown, the visual map 18 may include icons 22, representing particular areas of interest, such as the exemplary hotel, bus terminal and restaurant illustrated, as well as geographic features, such as a waterfront. The visual map 18 may also include an icon or other indicator denoting the user's location on map 18. The visual map 18 may include visual coordinates (such as the grid illustrated in FIG. 2) or printed latitude and longitude coordinates, for example (shown generally as 36 in FIG. 4). The user's location is continuously determined and represented, in changing updated format, on display 50. The choice of icons 22 is customizable and selectable, with a set of selectable icons being stored in the database. The visual representation of icons 22 may be selectively edited by the user.

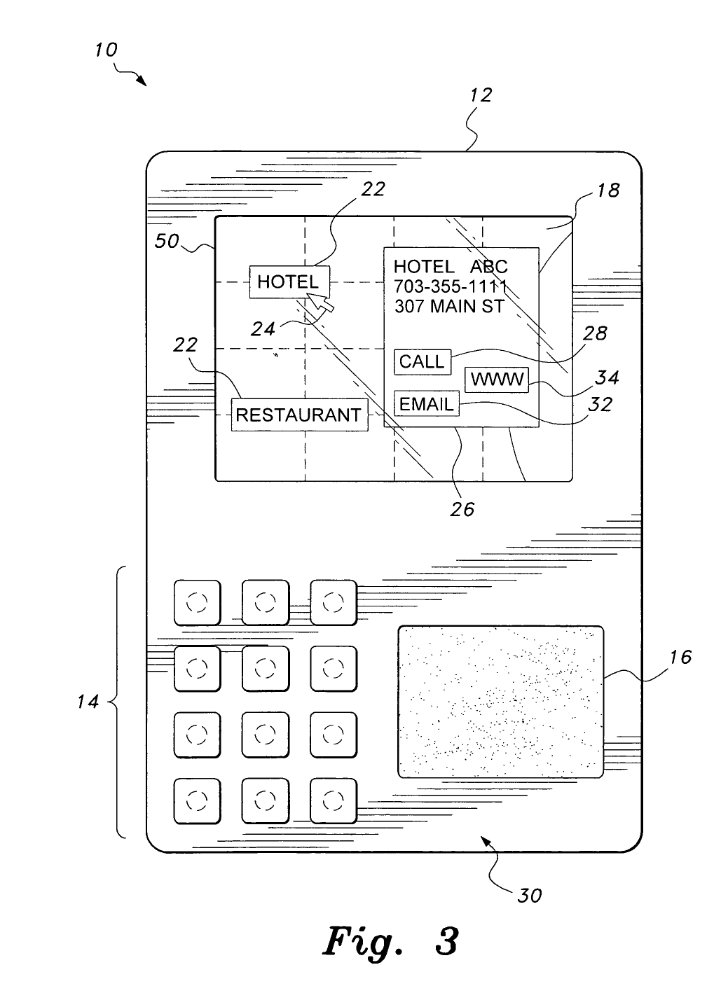

As illustrated in FIG. 3, if the user wishes to visit, or gain more information regarding, a particular area of interest, the user may use the interface 30 to manipulate a cursor 24, or the like, to point to the particular area of interest. In the example shown in FIG. 3, the user wishes to receive more information regarding a local hotel, and manipulates the cursor 24 to point to the hotel icon 22.

An information box or window 26 is generated by CPU 20 for display on display 50, adjacent the area of interest. The information box or window 26 may include generalized information in the form of text or graphics, and may further include contact information, such as a telephone number, universal resource locator (URL) for Internet access, or an e-mail address. As shown in FIG. 3, the user may automatically contact the exemplary hotel through use of virtual buttons or icons 28, 32, 34, allowing the user the choice of calling the hotel via telephone, sending an email or visiting the hotel's website, respectively. The user may customize and edit the information displayed, or select a preferred mode of communication, such as, for example, the selection of a fax number or e-mail address.

The information regarding the particular area of interest is stored within the database of memory 40 and may be customized or edited by the user. The display of the information box 26 is represented by step 150 in FIG. 6, and contacting the location or service of interest is represented by step 1 70. The contact and communication is performed by communication device 70, which sends and receives signals 230, 200 to and from local service provider 210. Local service provider 210 may alternatively be a computer or network associated directly with the area of interest, such as the exemplary hotel, and the information presented on device 10 may be transmitted directly from the hotel via a Bluetooth® compliant RF signal, for example, or through a Wi-Fi or Wi-Max signal.

Alternatively, the database may include a wide variety of areas of interest and services offered in a particular geographic region, and the user may search these areas, which are stored in the database. The user may then find a service of interest (step 160) utilizing a conventional database search algorithm. Alternatively, the listing of services and areas of interest within the geographic region may be transmitted to device 10 through the local service provider 210. The listing of areas of interest (and the display of those areas of interest on display 50) may be edited and customized by the user. For example, the user may delete an entry and/or accompanying icon 22, or edit the textual information displayed regarding the area of interest.

In use, the user may search the database for the travel agency in closest proximity to the user, for example, and then display the corresponding information (in box 26) for the travel agency. The user may then display the travel agency's website (by actuating the virtual button 34) to book travel plans. Alternatively, the user may initiate a telephone call, send e-mail or send a text message to the travel agency.

The user may further selectively control the display of location-specific advertisements (step 130), such as advertisement box 38, shown in FIG. 4, on display 50. Advertisements 38 are preferably related to the particular geographic area of the device 10, and advertise various services and areas of interest within the geographic area. Advertisements 38 may be stored in the database of memory 40 or may be transmitted to device 10 from the local service provider 210. Additionally, the advertisements 38 may be automatically updated, removed or replaced through automatic data transmissions with the local service provider 210.

It should be understood that the software and algorithms utilized by mobile device 1 0 are preferably stored within the storage medium 40, which may include, but is not limited to, random access memory (RAM), read only memory (ROM) or a removable storage medium, such as, for example, flash memory, a CD-ROM or a magnetic storage medium.

The user may further use mobile device 10 as a conventional portable computing device with network capability. For example, the user may use device 10 to visit websites on the Internet, send e-mail, send text messages or place telephone calls, either through the local cellular telephone network or using the voice over Internet protocol (VOIP).

It is to be understood that the present invention is not limited to the embodiments described above, but encompasses any and all embodiments within the scope of the following claims.

I claim:

1. A method for providing location-based interactive display and communication, comprising the steps of:
providing a mobile device;
geographically locating the mobile device and defining a geographic location of the mobile device;
defining a geographic region about the geographic location of the mobile device;
displaying a visual map of the geographic region on the mobile device;
providing at least one icon on the visual map, the at least one icon representing a selected area of interest;
selecting the at least one icon;
displaying information related to the selected area of interest on the mobile device; and,
selectively displaying advertisements related to the geographic region on the mobile device.

2. The method for providing location-based interactive display and communication as recited in claim 1, further comprising the steps of:
providing a storage medium for the mobile device;
establishing a database in the storage medium; and,
storing a plurality of visual maps in the database, each of the visual maps being related to a corresponding geographic region.

3. The method for providing location-based interactive display and communication as recited in claim 2, further comprising the step of storing a plurality of sets of icons in the database, each set of icons being related to a corresponding one of the geographic regions.

4. The method for providing location-based interactive display and communication as recited in claim 1, wherein said step of geographically locating the mobile device includes communicating with the global positioning system.

5. The method for providing location-based interactive display and communication as recited in claim 1, wherein said step of geographically locating the mobile device includes communicating with a local service provider.

6. The method for providing location-based interactive display and communication as recited in claim 1, wherein said step of displaying information related to the selected area of interest includes displaying communication information for the selected area of interest.

7. The method for providing location-based interactive display and communication as recited in claim 6, further comprising the step of selectively communicating with the selected area of interest.

8. The method for providing location-based interactive display and communication as recited in claim 1, further comprising the step of visually displaying the geographic location of the mobile device on the visual map of the geographic region.

9. The method for providing location-based interactive display and communication as recited in claim 3, further comprising the steps of:
storing the information related to the selected area of interest in the database; and,
selectively editing the information related to the selected area of interest.

10. The method for providing location-based interactive display and communication as recited in claim 3, further comprising the step of storing the advertisements in the database.

11. The method for providing location-based interactive display and communication as recited in claim 10, further comprising the steps of:
communicating with a local service provider associated with the geographic region; and,
selectively updating the advertisements stored in the database.

12. The method for providing location-based interactive display and communication as recited in claim 11, wherein advertisements related to the selected area of interest are communicated to the mobile device.

13. The method for providing location-based interactive display and communication as recited in claim 3, further comprising the step of selectively editing the plurality of sets of icons stored in the database.

14. A system for displaying location-based interactive data and providing communication, comprising:
a housing;
a processor received within said housing;
a storage medium received within said housing, said storage medium being in communication with said processor, the storage medium being adapted for storing a database;
a display mounted on said housing and being in communication with said processor;
a user interface device mounted on said housing and being in communication with said processor;
a communication device mounted within the housing and in communication with said processor; and,
a positioning device mounted received within said housing and being in communication with said processor, said positioning device determining a geographic location of the user, whereby said display displays a visual map of a geographic region about the geographic location, the visual map being stored in the database, the visual map including at least one icon associated with a user-selectable area of interest, information related to the user-selectable area of interest being stored in the database, said communication device being adapted for selective communication with the user-selectable area of interest, a plurality of location-specific advertisements further being stored in the database, the plurality of location-specific advertisements being selectively displayed on said display.

15. The system for displaying location-based interactive data and providing communication as recited in claim 14, wherein said positioning device is adapted for communication with the global positioning system.

16. The system for displaying location-based interactive data and providing communication as recited in claim 14, wherein said positioning device is adapted for communication with a local service provider.

17. The system for displaying location-based interactive data and providing communication as recited in claim 14, wherein the database is adapted to include editing software, whereby the user may selectively edit the at least one icon.

18. The system for displaying location-based interactive data and providing communication as recited in claim 14, wherein the database is adapted to include editing software, whereby the user may selectively edit the information related to the user-selectable area of interest.

19. The system for displaying location-based interactive data and providing communication as recited in claim 14, wherein the communication device and the database are adapted for updating the plurality of location-specific advertisements, a set of updated advertisements being transmitted to the communication device from a local service provider.
